(19) United States
(12) Patent Application Publication
(10) Pub. No.: US 2024/0188600 A1
(43) Pub. Date: Jun. 13, 2024

(54) SMART AND SCALABLE EXTREME VACUUM COOLING FOR FOOD RAPID CHILL AND CONTROLLED ENVIRONMENTAL AGRICULTURE

(71) Applicant: Culinary Sciences, Inc., Campbell, CA (US)

(72) Inventors: George Shu-Xing Cheng, Folsom, CA (US); John Field, Campbell, CA (US); Richard Gillespie, San Jose, CA (US); Mark Linder, St. Helena, CA (US)

(21) Appl. No.: 18/079,689

(22) Filed: Dec. 12, 2022

(51) Int. Cl. A23L 3/36; A23B 7/04; A23B 7/148; A23L 3/00; A23L 3/3418; F25D 21/14

(52) U.S. Cl. CPC A23L 3/363; A23B 7/0425; A23B 7/148; A23L 3/001; A23L 3/3418; F25D 21/14

(57) ABSTRACT

A method and apparatus is disclosed relating to controlled environment agriculture (CEA), food processing facilities, and commercial kitchens. The inventive smart and scalable extreme vacuum cooling (EVC) equipment is based on a scalable and modular design that allows one or multiple food chamber modules to connect to one utility module so that all food chambers can share the available vacuum cooling capacity dynamically.

A scalable EVC system can be built, shipped and assembled with as few as one food chamber module and one utility module to a number of food chamber modules and a utility module. The food chambers are designed with different sizes in dimension and power requirements but with the same interface to the utility module. In this way, multiple food chamber modules can operate for food rapid cooling and flavor infusion supported by only one utility module.

In a CEA farm, leafy greens are harvested daily and need to be chilled rapidly to comply with USDA food safety standards. Leafy greens can occupy a lot of space with a small vapor payload in vacuum cooling. The multiple food chamber modules to a single utility module design can save the total system cost, space, and energy.

For food flavor infusion in a commercial kitchen, brining and marinating take time. During the wait time, the food chamber is held at a low pressure condition without the need for pumping air out. During this time, the utility module can serve other food chambers. In this regard, an EVC system with multiple food chamber modules and a single utility module design will work well for food flavor infusion.

The smart and scalable EVC technology and equipment can make a big impact on commercial food preparation and controlled environment agriculture (CEA) for rapid chill to comply with food safety regulations. They are also very useful for food flavor infusion in commercial kitchens and food foundries.

The subject of this patent relates to controlled environment agriculture (CEA), food processing facilities, and commercial kitchens. More particularly, this patent relates to a method and apparatus for an environmentally sound rapid cooling solution for cooked foods and agriculture crops enabling users to achieve significant savings in water, land, fertilizer, manpower, time, and energy.

In U.S. patent application No. 17,469,712, the entirety of which is hereby incorporated by reference, we disclosed a method and apparatus of Extreme Vacuum Cooling (EVC), where an EVC cooler can work at ultra low pressure conditions with adaptive pressure control for processing large amounts of food to meet government food safety regulations, save energy and time, and achieve uniform cooling to retain good food quality. The Extreme Vacuum Cooling (EVC) technology is defined as vacuum cooling at extremely low pressure conditions with vacuum chamber pressure control and added clean dry air or inert gas.

In U.S. patent application No. 17,710,677, the entirety of which is hereby incorporated by reference, we described an extreme vacuum cooling (EVC) technology and apparatus for food flavor infusion. The EVC apparatus can work in ultra low pressure conditions to achieve much more time and energy efficient cooling and flavor infusion. Adaptive pressure control for the food chamber is implemented to avoid liquid splash so that the EVC apparatus can be used effectively for food rapid cooling and flavor infusion with substantial amount of time savings. Using the EVC food flavor infusion apparatus, large amounts of meats, vegetables, and fruits can be marinated or brined with various flavor infusion recipes.

Vacuum cooling is based on the principle of evaporative cooling, where water will absorb a large amount of heat in order to evaporate from liquid to gas. Water evaporation can happen at any temperature above the freezing point. When the chamber pressure of the EVC apparatus is intentionally reduced, the vapor pressure of the water inside the food can become higher than the chamber pressure, resulting in rapid conversion of water inside the food into vapor. This water evaporation transfers the energy to cool the food uniformly throughout the entire food substance. The conversion of water into vapor can happen quickly so that the resulting energy transfer can cool the food uniformly and rapidly.

In recent years, controlled environment agriculture (CEA) ranging from greenhouses to indoor and vertical farming has grown rapidly. CEA systems are designed to provide optimal growing conditions for crops with natural or artificial lighting and nutrient-dense water. Since the growing environment is well controlled, disease and pest damage can be prevented for crops resulting in better quality and more consistent and efficient productivity. Because climate change, global pandemic, and war have the potential to disrupt traditional land based agriculture, controlled environment agriculture can become an important part of a robust and nutritious food supply across the globe.

CEA can produce high-quality food close to consumers using minimal water, nutrients, chemicals, and human labor. CEA systems can also be placed in urban areas not suitable for traditional agriculture, bringing food production closer to consumers and making use of existing space.

In this patent, we introduce a smart and scalable extreme vacuum cooling (EVC) apparatus based on a scalable and modular design so that one or multiple food chamber modules can connect to a utility module so that all food chambers can share the available vacuum cooling capacity dynamically. This unique design is well suited for EVC rapid cooling applications where the vapor load from the food chamber is much smaller than the full capability of the utility module. By sharing the vacuum cooling capacity provided by a utility module, an EVC apparatus with multiple food chambers can save equipment cost, energy consumption and space.

A scalable EVC system can be built, shipped and assembled with as few as one food chamber module and one utility module to a number of food chamber modules and a utility module. The food chambers are designed with different sizes in dimension and power requirements but with the same interface to the utility module. Therefore, multiple food chamber modules can perform food rapid cooling and flavor infusion supported by only one utility module.

In a CEA farm, leafy greens are harvested daily and need to be chilled rapidly to comply with USDA food safety standards. Leafy greens can occupy a lot of space with a small amount of vapor payload in vacuum cooling. Thus, the multiple food chamber modules to a single utility module design can save the total system cost, space, and energy.

For food flavor infusion in a commercial kitchen, brining and marinating take time. During the wait time, the food chamber is held at a low pressure condition without the need for pumping air out. Thus, the utility module can serve other food chambers. In this regard, an EVC system with multiple food chamber modules and a single utility module design will work well for food flavor infusion.

The smart and scalable EVC technology and equipment can make a big impact on commercial food preparation and controlled environment agriculture (CEA) for rapid chill to comply with food safety regulations. They are also very useful for food flavor infusion in commercial kitchens and food foundries.

### IN THE ACCOMPANYING DRAWING

FIG. 1 is a perspective view of an EVC cooling and food flavor infusion apparatus with a 2×1 design that comprises two food chamber modules and a utility module that includes two vacuum control valves, according to an embodiment of this invention.

FIG. 2 is a perspective view of an EVC cooling and food flavor infusion apparatus with a 2×1 design that comprises two food chamber modules and a utility module, where each food chamber module comprises a vacuum control valve, according to an embodiment of this invention.

FIG. 3 is a perspective view of an EVC cooling and food flavor infusion apparatus with a N×1 design that comprises multiple food chamber modules and a utility module that includes multiple vacuum control valves, according to an embodiment of this invention.

FIG. 4 is a perspective view of an EVC cooling and food flavor infusion apparatus with a N×1 design that comprises multiple food chamber modules and a utility module, where each food chamber module comprises a vacuum control valve, according to an embodiment of this invention.

FIG. 5 is a perspective view of an EVC cooling and food flavor infusion apparatus with a 2×1 design that comprises two food chamber modules and a utility module that includes two vacuum control valves, showing all major components with a chamber pressure control system, according to an embodiment of this invention.

FIG. 6 is a perspective view of an EVC cooling and food flavor infusion apparatus with a N×1 design that comprises multiple food chamber modules and a utility module, where each food chamber module comprises a vacuum control valve, showing all major components with a chamber pressure control system, according to an embodiment of this invention.

FIG. 7 is a perspective view of an EVC cooling apparatus with a N×1 design that comprises multiple food chamber modules and a utility module that includes one vacuum control valve, showing all major components with a food chamber temperature or pressure control system, according to an embodiment of this invention.

FIG. 8 is a perspective front view of a food chamber module and a control and monitoring module with key components for the EVC cooling and food flavor infusion apparatus, according to an embodiment of this invention.

FIG. 9 is a diagram of a 2-Input-1-Output (2×1) pressure control system to control the chamber pressure of the EVC cooling and food flavor infusion apparatus, according to an embodiment of this invention.

FIG. 10 is a drawing illustrating a mechanism of a reverse split-range setter that can split the controller signal into 2 ranges to manipulate the vacuum control valve and inflow air control valve, according to an embodiment of this invention.

FIG. 11 is a time-amplitude diagram that shows a chamber pressure setpoint trajectory for cooling high viscosity foods, controlled chamber pressure, boiling point temperature, and food temperature, according to an embodiment of this invention.

FIG. 12 is a time-amplitude diagram that shows a chamber pressure setpoint trajectory for cooling low viscosity foods and for food flavor infusion, as well as boiling point temperature and food temperature, according to an embodiment of this invention.

The term mechanism is used herein to represent hardware, software, or any combination thereof. The term EVC refers to Extreme Vacuum Cooling defined and described in this patent application. The term EVC cooling and food flavor infusion equipment refers to the extreme vacuum cooling apparatus introduced in this patent. The term HMI refers to Human Machine Interface that includes a computer screen to allow a user to interact with a device. The term IPC refers to Industrial Personal Computers. The term PLC refers to Programmable Logic Controllers. The term PAC refers to Programmable Automation Controllers.

In this patent, we define solid foods with high viscosity as Type A Foods, and liquid foods with low viscosity as Type B Foods. For example, Type A Foods include beef, pork, chicken, potatoes, baked foods, and sautéed meats and vegetables. Type B Foods includes marinade, brine, salt water, wine, juices, oil, soup, stews, sauces, and spaghetti in sauce.

Throughout this document, n=1, 2, 3, . . . , as an integer, which is used to indicate the number of food chamber modules that the EVC apparatus comprises.

Without losing generality, all numerical values given in this patent are examples. Other values can be used without departing from the spirit or scope of this invention. The description of specific embodiments herein is for demonstration purposes and in no way limits the scope of this disclosure to exclude other not specially described embodiments of this invention.

### DESCRIPTION

A. Apparatus of Extreme Vacuum Cooling with Multiple Food Chambers

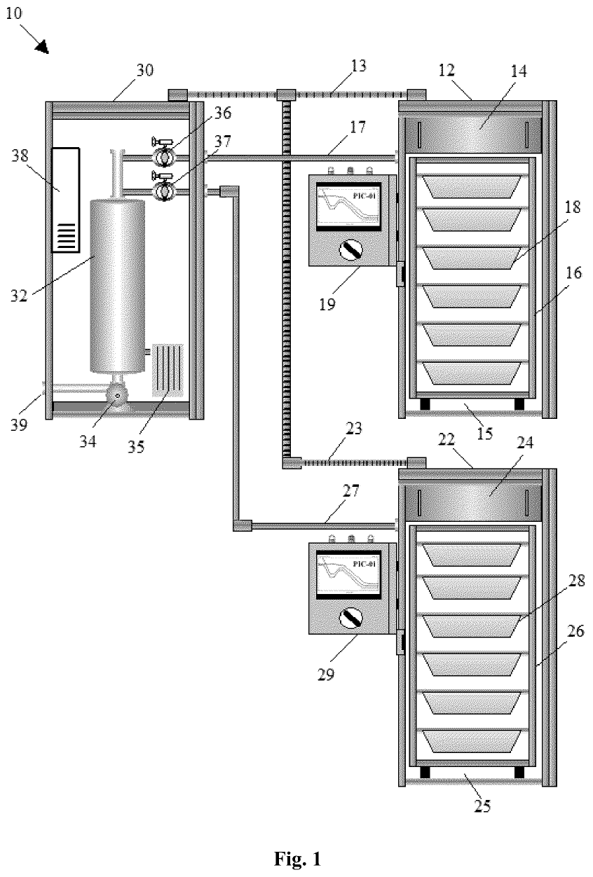

An extreme vacuum cooling (EVC) apparatus having three design embodiments with adaptive chamber pressure control or temperature control for food rapid cooling and flavor infusion are illustrated in FIGS. 1 to 8.

FIG. 1 is a perspective view of an EVC cooling and food flavor infusion apparatus with a 2×1 design that comprises two food chamber modules and a utility module that includes two vacuum control valves, according to an embodiment of this invention.

The EVC cooling and food flavor infusion apparatus 10 comprises two food chamber modules 12 and 22. The food chamber module 12 comprises a food chamber 15, an instrument panel 14, a trolley being rolled inside the food chamber 16, food pans or crop cartons on the trolley 18, and a control and monitoring module 19. The food chamber module 22 comprises a food chamber 25, an instrument panel 24, a trolley being rolled inside the food chamber 26, food pans or crop cartons on the trolley 28, and a control and monitoring module 29.

The food chamber modules 12 and 22 and food chambers 15 and 25 are built to work in extremely low pressure conditions. In this embodiment, the extremely low pressure conditions can be defined as being less than or equal to about 0.1 ATM or 10 kPa. The food pan or crop carton trolleys 16 and 26 could be built with stainless steel with multiple racks to hold food pans or crop cartons. In a commercial kitchen, the foodstuffs such as meats, vegetables, noodles, and soup are put inside the food pans 18 and 28. In a controlled environment agriculture (CEA) farm, crops such as leafy greens, berries, and fruits are put inside crop cartons 18 and 28. Each instrument panel 14 and 24 comprises sensors, an inflow air control valve, an air filter, electrical wires, and signal wires.

Each control and monitoring module 19 and 29 comprises a control and monitoring computer with HMI screen. It is mounted on its corresponding food chamber module and can provide chamber pressure control and logic control for the EVC apparatus. The human-machine-interface (HMI) screens allow the user to operate the apparatus and the corresponding food chamber modules. Each food chamber module has its own control and monitoring module so that it can run independently regardless of the condition of the other food chamber.

As illustrated in FIG. 1, the EVC cooling and food flavor infusion apparatus 10 also comprises a utility module 30, which further comprises a cold trap 32, a vacuum pump 34, a refrigeration unit 35, two vacuum control valves 36, 37, an electrical panel 38, and an outflow air outlet 39. In addition, the apparatus 10 comprises vacuum air connection tubing and connectors 17 and 27 to connect the vacuum air between food chambers 15 and 25 and utility module 30, respectively. Apparatus 10 also comprises electrical and signal wire conduit 13 and 23 to connect the electrical and digital wires between the food chamber modules 14 and 24 to the utility module 30.

In FIG. 1, the cold trap 32 is used to condense water vapor from the food chamber back to liquid form. The vacuum pump 34 can pump air out of the food chamber to reach extremely low pressure conditions. The vacuum control valves 36 and 37 are used to isolate the cold trap 32 from food chambers 15 and 25. These two control valves can also regulate the outflow air when the vacuum pump 34 is pumping air out of the corresponding food chamber. Therefore, each control valve is used as one of the actuators to control the corresponding food chamber pressure. The refrigeration unit 35 is used to cool down the cold trap 32 to condense water vapor. The outflow air outlet 39 allows the air to be pumped out to the atmosphere. The electrical panel 38 is used to receive electric power and supply power to the EVC apparatus. Since the apparatus is for the global market, different electric standards throughout the world can be supported. Therefore, the apparatus can be designed to take either 3-phase AC power or single-phase AC power from the local electric grid.

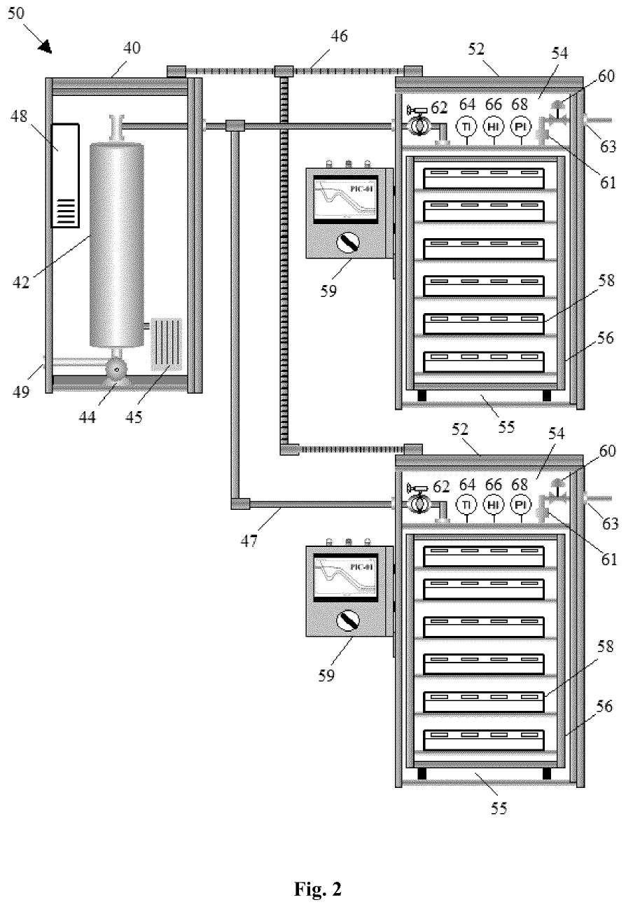

FIG. 2 is a perspective view of an EVC cooling and food flavor infusion apparatus with a 2×1 design that comprises two food chamber modules and a utility module, where each food chamber module comprises a vacuum control valve, according to an embodiment of this invention.

The EVC cooling and food flavor infusion apparatus 50 comprises two food chamber modules 52. Each food chamber module 52 comprises a food chamber 55, an instrument panel 54, a trolley being rolled inside the food chamber 56, food pans or crop cartons on the trolley 58, and a control and monitoring module 59. Each instrument panel 54 further comprises an inflow air control valve 60, an inline air filter 61, an inflow air inlet 63, a vacuum control valve 62, temperature sensors 64, a humidity sensor 66, and a pressure sensor 68.

The temperature sensors 64, humidity sensor 66, and pressure sensor 68 are part of the instrument panel 54. The actual sensor probes are installed inside the food chamber at different locations. For instance, there can be multiple temperature sensor probes that are inserted into food samples in different food pans to measure the food temperature. The humidity sensor probe and pressure sensor probe are typically installed at the top of the food chamber.

In FIG. 2, each food chamber module 52 and food chamber 55 is built to work in extremely low pressure conditions. In this embodiment, the extremely low pressure conditions can be defined as being less than or equal to about 0.1 ATM or 10 kPa. Each food pan or crop carton trolley 56 could be built with stainless steel with multiple racks to hold food pans or crop cartons. In a commercial kitchen, the foodstuffs such as meats, vegetables, noodles, and soup are put inside the food pans 58. In a controlled environment agriculture (CEA) farm, crops such as leafy greens, berries, and fruits are put inside crop cartons 58.

Each control and monitoring module 59 is mounted on the corresponding food chamber module and can provide chamber pressure control and logic control for the EVC apparatus. A human-machine-interface (HMI) screen allows the user to operate the apparatus and the corresponding food chamber modules. Each food chamber module has its own control and monitoring module so that it can run independently regardless of the condition of the other food chamber.

As shown in FIG. 2, the EVC cooling and food flavor infusion apparatus 50 also comprises a utility module 40, which further comprises a cold trap 42, a vacuum pump 44, a refrigeration unit 45, an electrical panel 48, and an outflow air outlet 49. In addition, the EVC apparatus 50 comprises: (1) vacuum air connection tubing and connectors 47 to connect the vacuum air between food chambers 55 and utility module 40; and (2) electrical and signal wire conduit 46 to connect the electrical and digital wires between the food chamber module 52 and the utility module 40.

In FIG. 2, the cold trap 42 is used to condense water vapor from the food chambers back to liquid form. The vacuum pump 44 can pump air out of the food chambers to reach extremely low pressure conditions. The refrigeration unit 45 is used to cool down the cold trap 42 to condense water vapor. The outflow air outlet 49 allows the air to be pumped out to the atmosphere. The electrical panel 48 is used to receive electric power and supply power to the EVC apparatus.

In this design, the vacuum control valve 62 is installed inside the instrument panel of the food chamber module 52. This control valve is used to: (1) isolate the cold trap 42 in the utility module from the food chamber 55; and (2) regulate the outflow air when the vacuum pump 44 is pumping the air out of the food chamber.

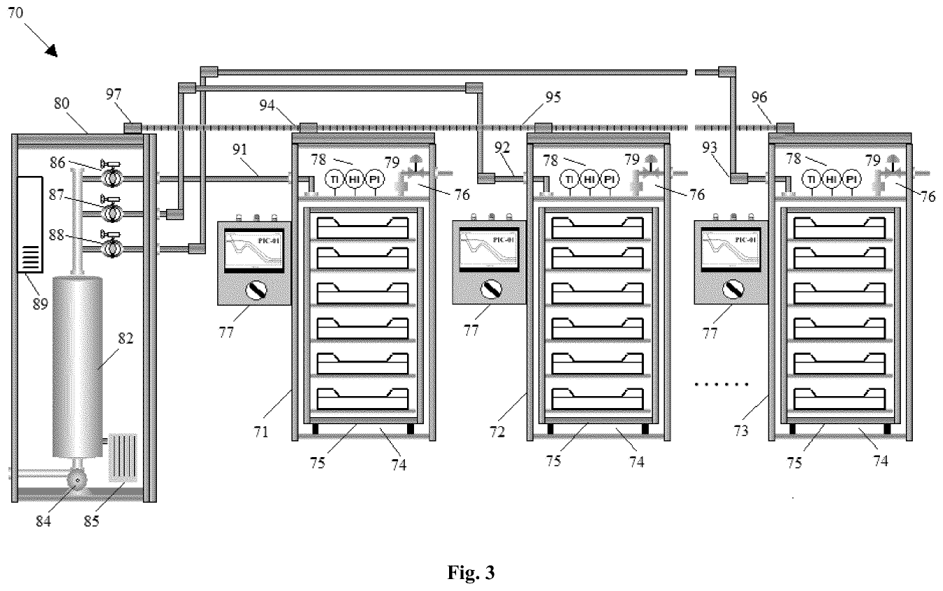

FIG. 3 is a perspective view of an EVC cooling and food flavor infusion apparatus with a N×1 design that comprises multiple food chamber modules and a utility module that includes multiple vacuum control valves, according to an embodiment of this invention.

The EVC cooling and food flavor infusion apparatus 70 comprises multiple food chamber modules 71, 72, . . . , 73. The food chamber module 73 is the Nth module, where N is an integer. For instance, if N=5, then the apparatus 70 has 5 food chamber modules. Each food chamber module 71, 72, and 73 comprises a food chamber 74, a trolley being rolled inside the food chamber 75, an instrument panel 76, and a control and monitoring module 77. Each instrument panel 76 further comprises a set of temperature, humidity, and pressure sensors 78 and an inflow air control valve 79.

As shown in FIG. 3, the EVC cooling and food flavor infusion apparatus 70 also comprises a utility module 80, which further comprises a cold trap 82, a vacuum pump 84, a refrigeration unit 85, an electrical panel 89, and vacuum control valves 86, 87, . . . 88. The vacuum control valve 88 is the Nth valve, where N is an integer. For instance, if N=5, then the utility module comprises 5 vacuum control valves.

The cold trap 82 is used to condense water vapor from the food chambers back to liquid form. The vacuum pump 84 can pump air out of the food chambers to reach extremely low pressure conditions. The refrigeration unit 85 is used to cool down the cold trap 82 to condense water vapor. The electrical panel 89 is used to receive electric power and supply power to the EVC apparatus.

In FIG. 3, food chamber module 71 comprises vacuum air connection tubing and connectors 91 to connect the vacuum air between the food chamber and vacuum control valve 86 inside the utility module 70. Food chamber module 72 comprises vacuum air connection tubing and connectors 92 to connect the vacuum air between the food chamber and vacuum control valve 87 inside the utility module 70. Food chamber module 73 comprises vacuum air connection tubing and connectors 93 to connect the vacuum air between the food chamber and vacuum control valve 88 inside the utility module 70.

Food chamber modules 71. 72, and 73 also comprise electrical and signal wire conduit 94, 95, and 96 to connect the electrical and digital wires between the food chamber modules and the utility module 80 through an electrical and signal wire conduit 97 on the utility module 70.

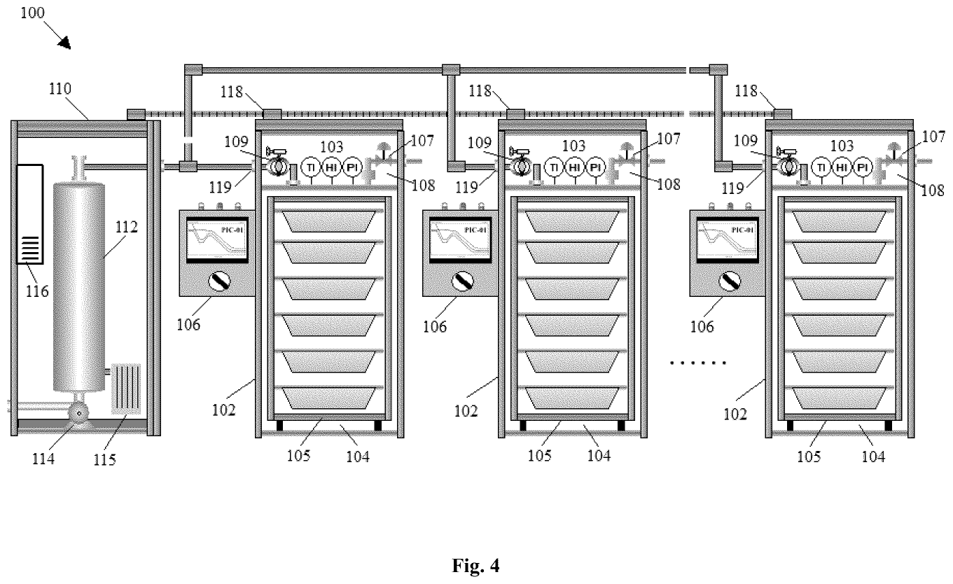

FIG. 4 is a perspective view of an EVC cooling and food flavor infusion apparatus with a N×1 design that comprises multiple food chamber modules and a utility module, where each food chamber module comprises a vacuum control valve, according to an embodiment of this invention.

The EVC cooling and food flavor infusion apparatus 100 comprises multiple food chamber modules 102, each of which further comprises a food chamber 104, a trolley being rolled inside the food chamber 105, an instrument panel 108, and a control and monitoring module 106. Each instrument panel 108 further comprises a set of temperature, humidity, and pressure sensors 103, an inflow air control valve 107, and a vacuum control valve 109.

As shown in FIG. 4, the EVC cooling and food flavor infusion apparatus 100 also comprises a utility module 110, which further comprises a cold trap 112, a vacuum pump 114, a refrigeration unit 115, and an electrical panel 116. The cold trap 112 is used to condense water vapor from the food chambers back to liquid form. The vacuum pump 114 can pump air out of the food chambers to reach extremely low pressure conditions. The refrigeration unit 115 is used to cool down the cold trap 112 to condense water vapor. The electrical panel 116 is used to receive electric power and supply power to the EVC apparatus. In this design, the utility module does not comprise any vacuum control valve.

In FIG. 4, each food chamber module 102 comprises vacuum air connection tubing and connectors 119 to connect the outlet of the vacuum control valve 109 to the cold trap 112 inside the utility module 110. Each food chamber module 102 also comprises electrical and signal wire conduit 118 to connect the electrical and digital wires between the food chamber modules and the utility module 110.

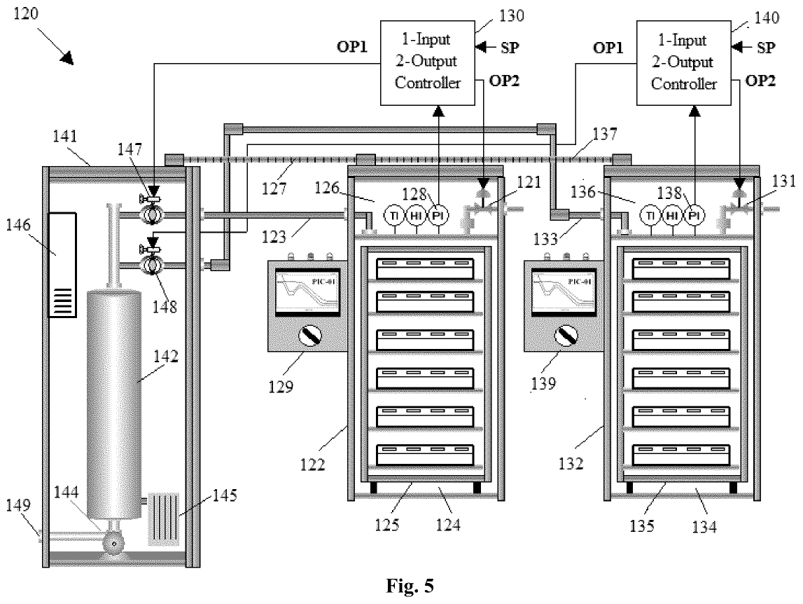

FIG. 5 is a perspective view of an EVC cooling and food flavor infusion apparatus with a 2×1 design that comprises two food chamber modules and a utility module that includes two vacuum control valves, showing all major components with a chamber pressure control system, according to an embodiment of this invention.

The EVC cooling and food flavor infusion apparatus 120 comprises two food chamber modules 122 and 132. The food chamber module 122 comprises a food chamber 124, a trolley being rolled inside the food chamber 125, an instrument panel 126, and a control and monitoring module 129. The food chamber module 132 comprises a food chamber 134, a trolley being rolled inside the food chamber 135, an instrument panel 136, and a control and monitoring module 139. The instrument panels 126 and 136 further comprise a set of temperature, humidity, and pressure sensors 128 and 138, and an inflow air control valve 121 and 131, respectively.

As shown in FIG. 5, the EVC cooling and food flavor infusion apparatus 120 also comprises a utility module 141, which further comprises a cold trap 142, a vacuum pump 144, a refrigeration unit 145, an electrical panel 146, vacuum control valves 147 and 148, and an outflow air outlet 149. Apparatus 120 also comprises 1-Input-2-Output controllers 130 and 140 for the food chamber modules 122 and 132, respectively.

In FIG. 5, food chamber modules 122 and 132 comprise vacuum air connection tubing and connectors 123 and 133 to connect the vacuum air between the food chamber and vacuum control valves 147 and 148 inside the utility module 141, respectively. Food chamber module 122 and 132 also comprise electrical and signal wire conduit 127 and 137 to connect the electrical and digital wires between the food chamber modules and the utility module 141.

The temperature sensors, humidity sensor, and pressure sensor are part of the instrument panels 126 and 136. The actual sensor probes are installed inside the food chamber at different locations. For instance. there can be multiple temperature sensor probes that are inserted into food samples in different food pans to measure the food temperature. The humidity sensor probe and pressure sensor probe are typically installed at the top of the food chamber.

In FIG. 5, the 1-Input-2-Output (1×2) controller 130 can provide adaptive chamber pressure control for food chamber 124. The 1×2 pressure controller 130 receives measured pressure as process variable (PV) from pressure sensor 128, compares it with its pressure setpoint (SP), and provides a control signal to either manipulate the inflow air control valve 121 or the vacuum control valve 147 in the utility module to control the chamber pressure of food chamber 124. Similarly, the 1×2 pressure controller 140 receives measured pressure as process variable (PV) from pressure sensor 138, compares it with its pressure setpoint (SP), and provides a control signal to either manipulate the inflow air control valve 131 or the vacuum control valve 148 in the utility module to control the chamber pressure of food chamber 134.

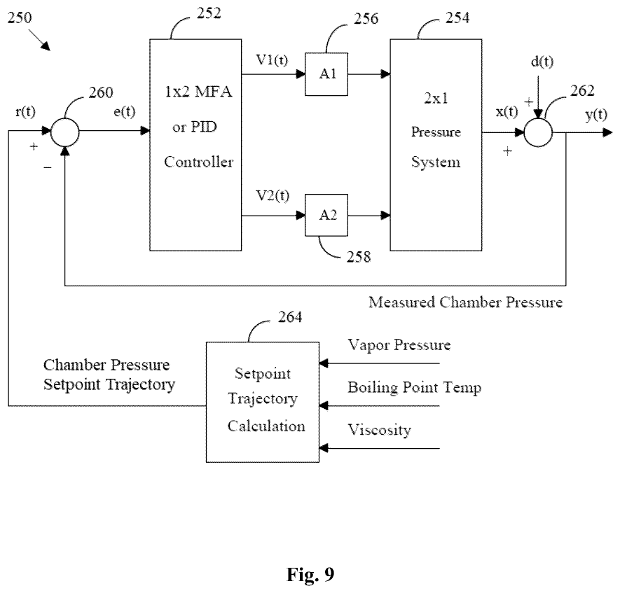

In order to avoid liquid splash, it is important to control the chamber pressure based on a pre-determined pressure setpoint trajectory that is based on food types, viscosity, chamber pressure, food temperature, and boiling point temperature. For food flavor infusion, the foodstuff is submerged in the marinade or brine, which typically have low viscosity. The chamber pressure setpoint trajectory for brining should be determined based on the viscosity of salt water, and the pressure setpoint trajectory for marinating should be determined based on the viscosity of a specific marinade. The chamber pressure control system is described in more details in FIGS. 9 to 12.

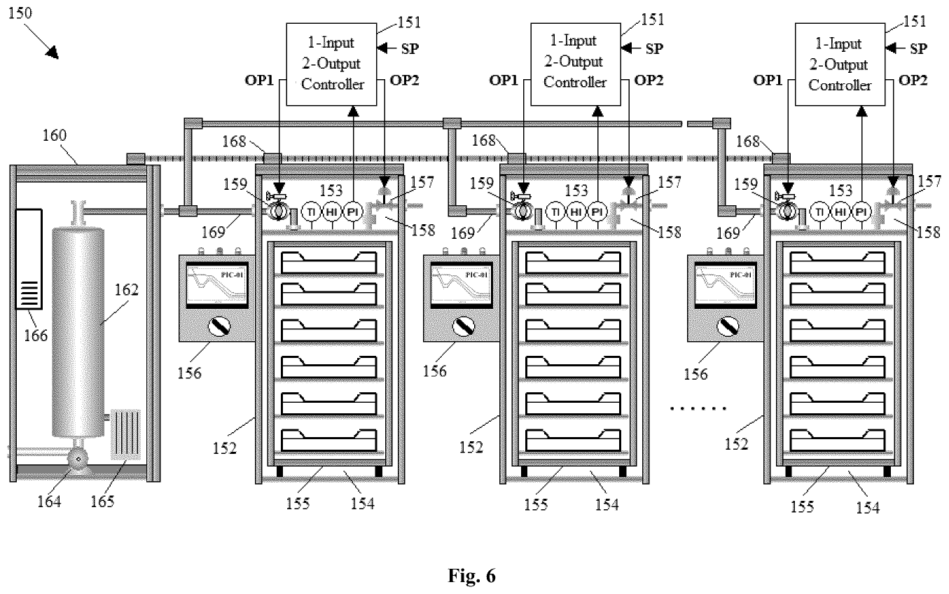

FIG. 6 is a perspective view of an EVC cooling and food flavor infusion apparatus with a N×1 design that comprises multiple food chamber modules and a utility module, where each food chamber module comprises a vacuum control valve, showing all major components with a chamber pressure control system, according to an embodiment of this invention.

The EVC cooling and food flavor infusion apparatus 150 comprises multiple food chamber modules 152, each of which further comprises a food chamber 154, a trolley being rolled inside the food chamber 155, an instrument panel 158, and a control and monitoring computer with HMI screen 156. Each instrument panel 158 further comprises a set of temperature, humidity, and pressure sensors 153, an inflow air control valve 157, and a vacuum control valve 159.

As shown in FIG. 6, the EVC cooling and food flavor infusion apparatus 150 also comprises a utility module 160, which further comprises a cold trap 162, a vacuum pump 164, a refrigeration unit 165, and an electrical panel 166. The cold trap 162 is used to condense water vapor from the food chambers back to liquid form. The vacuum pump 164 can pump air out of the food chambers to reach extremely low pressure conditions. The refrigeration unit 165 is used to cool down the cold trap 162 to condense water vapor. The electrical panel 166 is used to receive electric power and supply power to the EVC apparatus. In this design, the utility module does not comprise any vacuum control valve.

In FIG. 6, each food chamber module 152 comprises vacuum air connection tubing and connectors 169 to connect the outlet of the vacuum control valve 159 to the cold trap 162 inside the utility module 160. Each food chamber module 152 also comprises electrical and signal wire conduit 168 to connect the electrical and digital wires between the food chamber modules and the utility module 160.

As shown in FIG. 6, the EVC apparatus 150 also comprises a 1-Input-2-Output controller 151 for each food chamber module 152, respectively. The 1-Input-2-Output (1×2) controller 151 can provide adaptive chamber pressure control for its corresponding food chamber. The 1×2 pressure controller 151 receives measured pressure as process variable (PV) from a corresponding pressure sensor, compares it with its pressure setpoint (SP), and provides a control signal to either manipulate the inflow air control valve 157 or the vacuum control valve 159 to control the chamber pressure of food chamber 154. The chamber pressure control system is described in more details in FIGS. 9 to 12.

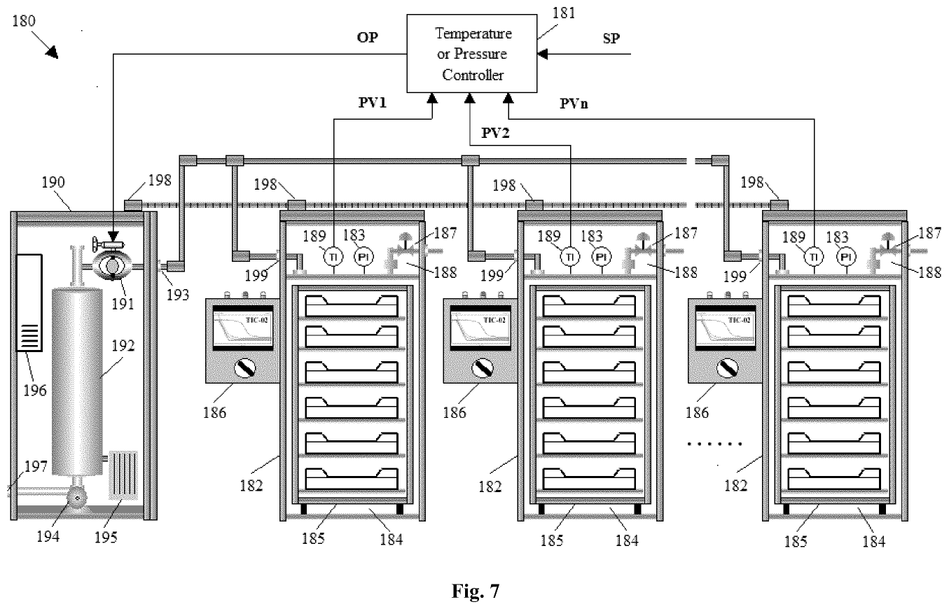

FIG. 7 is a perspective view of an EVC cooling apparatus with a N×1 design that comprises multiple food chamber modules and a utility module that includes one vacuum control valve. showing all major components with a food chamber temperature or pressure control system, according to an embodiment of this invention.

The EVC cooling and food flavor infusion apparatus 180 comprises multiple food chamber modules 182, each of which further comprises a food chamber 184, a trolley being rolled inside the food chamber 185, an instrument panel 188, and a control and monitoring module 186. Each instrument panel 188 further comprises a set of temperature sensors 189, a pressure sensor 183, and an inflow air control valve 187.

As shown in FIG. 7, the EVC cooling and food flavor infusion apparatus 180 also comprises a utility module 190, which further comprises a vacuum control valve 191, a cold trap 192, a vacuum pump 194, a refrigeration unit 195, an electrical panel 196, and an outflow air outlet 197. The cold trap 192 is used to condense water vapor from the food chambers back to liquid form. The vacuum pump 194 can pump air out of the food chambers to reach extremely low pressure conditions. The refrigeration unit 195 is used to cool down the cold trap 192 to condense water vapor. The electrical panel 196 is used to receive electric power and supply power to the EVC apparatus. In this design, the utility module comprises only one vacuum control valve 191.

In a CEA farm, leafy greens are harvested daily and need to be chilled rapidly to comply with USDA food safety standards. Leafy greens can occupy a lot of space with a small vapor payload in vacuum cooling. The multiple food chamber modules to a single utility module design can save the total system cost, space, and energy. In addition, if all the food chambers can start and stop their vacuum operations at the same time in a synchronized way, all vacuum air tubing can be connected together and feed to the single vacuum control valve 191 in the utility module 190. This can result in extra cost savings in building the EVC apparatus.

In FIG. 7, each food chamber module 182 comprises vacuum air connection tubing and connectors 199 to connect to the utility module vacuum air outlet 193 that connects to vacuum control valve 191 inside the utility module 190. Each food chamber module 182 also comprises electrical and signal wire conduit 198 to connect the electrical and digital wires between the food chamber modules and the utility module 190.

As shown in FIG. 7, the EVC apparatus 180 also comprises a temperature controller or pressure controller 181 to control the chamber temperature. The temperature controller 181 can provide temperature control for all food chambers. The temperature controller receives the measured temperature from temperature sensors 189 inside each food chamber, calculates an average temperature value and uses it as the process variable (PV) for the controller, compares it with its temperature setpoint (SP), and provides a control signal to manipulate the vacuum control valve 191 to control the chamber temperature.

In rapid chill applications, when the food temperature reaches the setpoint entered by the user, the EVC apparatus will end its vacuum cooling operation. The following steps shall then be performed: (1) the vacuum control valve is closed; (2) the inflow air control valve of each food chamber is opened so that the food chamber is vented to atmosphere pressure; (3) the system status lights change to a state to notify the user to take the products out of the food chamber; and (4) the user opens the food chamber door and removes the product trolley.

Alternatively, the EVC apparatus described in FIG. 7 can have a pressure control system instead of a temperature control system. In this case, the pressure controller 181 can provide pressure control for all food chambers. The pressure controller receives the measured pressure from pressure sensors 183 inside each food chamber, calculates an average pressure value and uses it as the process variable (PV) for the controller, compares it with its pressure setpoint (SP), and provides a control signal to manipulate the vacuum control valve 191 to control the chamber pressure. Please note that the signal line from each pressure sensor 183 to the pressure controller 181 is not shown.

In this application, the chamber temperature is not important so that it does not need to be controlled. The food chamber pressure is to be maintained at a certain level for a period of time. When a pre-determined time is reached, the vacuum cooling or marinating process is completed. The following steps shall then be performed: (1) the vacuum control valve is closed; (2) the inflow air control valve of each food chamber is opened so that the food chamber is vented to atmosphere pressure; (3) the system status lights change to a state to notify the user to take the products out of the food chamber; and (4) the user opens the food chamber door and removes the product trolley.

The actual operations and steps of using the EVC apparatus may vary but the basic concept is described in this patent application. All the key components of the EVC apparatus for rapid chill of produce in a CEA farm have been disclosed.

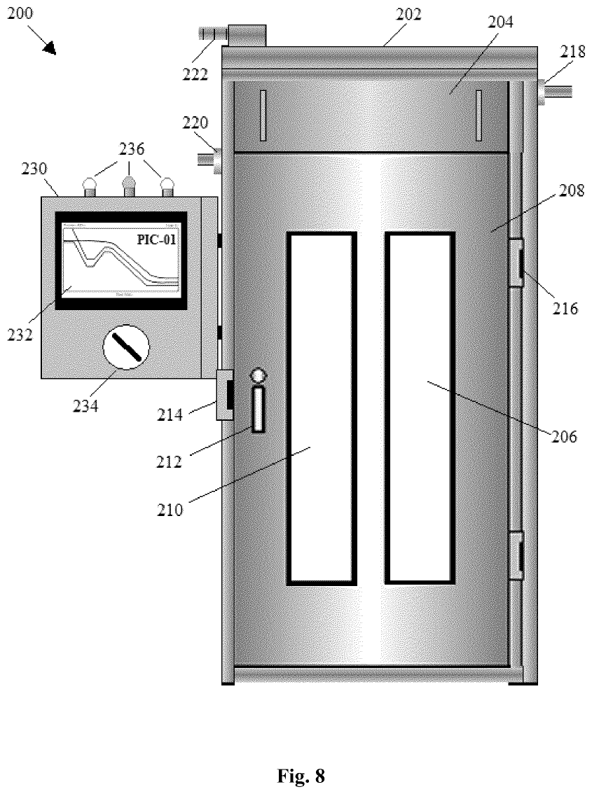

FIG. 8 is a perspective front view of a food chamber module and a control and monitoring module with key components for the EVC cooling and food flavor infusion apparatus, according to an embodiment of this invention.

The food chamber module and control and monitoring module set 200 comprises a food chamber module 202 and a control and monitoring module 230. The food chamber module 202 comprises a food chamber 206, an instrument panel 204, a food chamber door 208, food chamber door windows 210, a door handle and swivel 212, a door striker plate 214, and door hinges 216, an inflow air inlet 218, a vacuum air connection tubing and outlet 220, and an electrical and signal wire conduit outlet 222.

The control and monitoring module 230 comprises a control and monitoring computer with HMI screen 232, a system power switch 234, and system status lights 236.

In FIG. 8, the food chamber 206 is built to work in extremely low pressure conditions. The chamber door 208 allows easy access to the food chamber and can seal the food chamber from the atmosphere pressure. Since the apparatus can operate at extremely low pressure conditions, the food chamber and its door are specially designed and built to deal with the pressure difference of the atmosphere pressure and 0 Pascal vacuum pressure, which is about 100 kPa. The door handle and swivel 212 allow the user to open and close the door and can also lock the food chamber for safe operations. The door striker plate 214 is to latch the door securely, and door hinges 216 can hold the heavy food chamber door for safe operations.

The inflow air inlet 218 allows the air to flow into the food chamber to return the chamber pressure to atmosphere pressure. The inflow air is also important in chamber pressure control when we need to raise the chamber pressure by adding clean air to the chamber to avoid liquid splash events from happening.

The control and monitoring computer with HMI screen 232 can provide chamber pressure control and logic control for the apparatus, and the human-machine-interface (HMI) screen allows the user to operate the apparatus. The control and monitoring computer with HMI screen can be implemented with a few options, including: (a) an industrial personal computer (PC) with Windows or Linux operating system, (b) a programmable logic controller (PLC), (c) a programmable automation controller (PAC), (d) a specially designed control device, or (e) a combination thereof.

The system power switch 234 can turn the power of the apparatus on or off. The system status lights 236 can be designed with three lights. For instance, (a) a shining green light indicates the apparatus is in normal operation when the chamber pressure is at or below the atmosphere pressure; (b) a blinking green light indicates the food chamber is empty and ready to use; (c) a shining orange light indicates the cooling or marinating operation has ended and the chamber pressure is back to atmosphere pressure and products should be removed; (d) a blinking orange light indicates the chamber door is open and the system is not ready to start the vacuum operation; and (e) a shining red light indicates the system is in error or needs human attention.

Since there are multiple food chamber modules in operation, the system status lights on each food chamber module can provide important information for the users to attend to the appropriate food chamber modules to load and unload products and coordinate their efforts.

FIG. 8 is a perspective front view of a food chamber module, which does not show the back of the module. As an option, a food chamber module can be designed and built with two doors, one in the front and one at the back. Either door can allow easy access to the food chamber to load and unload products. An EVC apparatus with multiple 2-door food chamber modules can be especially useful in large food processing operations and CEA farms.

### B. Adaptive Chamber Pressure Control for the EVC Apparatus

Vacuum cooling is based on the principle of evaporative cooling, where water will absorb a large amount of heat in order to evaporate from liquid to gas. Water evaporation can happen at any temperature above the freezing point. When the chamber pressure of the EVC apparatus is intentionally reduced, the vapor pressure of the water inside the food can become higher than the chamber pressure, resulting in rapid conversion of water inside the food into vapor. This water evaporation transfers the energy to cool the food uniformly throughout the entire food substance. The conversion of water into vapor can happen quickly so that the resulting energy transfer can cool the food uniformly and rapidly.

However, if the pressure difference between the chamber pressure and vapor pressure of the water inside the food is too high, excessive bubbling can occur due to rapid evaporation. When the bubbles burst at the food surface, the force of the bubble surface tension can cause a splash inside the chamber. This is not an issue for solid foods, like beef and chicken as the food structure will not come apart when vapor moves through the food into the vacuum chamber. For low viscosity foods, such as soups and sauces, this can be a big issue. We call this a liquid splash event for those low viscosity foods.

In U.S. patent application No. 17,469,712, solid foods with high viscosity were defined as Type A Foods, and liquid foods with low viscosity were defined as Type B Foods. For example, Type A Foods include beef, pork, chicken, potatoes, baked foods, and sautéed meats and vegetables. Type B Foods include soup, stews, sauces, and spaghetti in sauce. There can be gray areas for being actual Type A or B Foods. In any case, viscosity is used in food cooling recipes and chamber pressure setpoint calculations to ensure that the EVC apparatus can cool all type of foods with good and consistent performance.

Liquid splash events can contaminate the food chamber when the interior chamber surfaces and shelving fixtures are coated with food liquids and sauces. It is important to control the chamber pressure carefully for Type B Foods so that the pressure difference between the chamber pressure and vapor pressure is managed properly and automatically to enable rapid cooling and avoid liquid splash.

FIG. 9 is a diagram of a 2-Input-1-Output (2×1) pressure control system to control the chamber pressure of the EVC cooling and food flavor infusion apparatus, according to an embodiment of this invention.

The 2-Input-1-Output (2×1) pressure control system 250 comprises a 1-input-2-output (1×2) controller 252, a 2-input-1-output (2×1) system 254, actuator A₁ 256, actuator A₂ 258, signal adders 260 and 262, and a setpoint trajectory calculation mechanism 264. The signals shown in FIG. 9 are as follows:
r(t)—Setpoint.
y(t)—Measured Variable or the Process Variable, y(t)=x(t)+d(t).
x(t)—System Output.
V₁(t)—Controller Output 1 to manipulate Actuator A₁.
V₂(t)—Controller Output 2 to manipulate Actuator A₂
d(t)—Disturbance, the disturbance caused by noise or load changes.
e(t)—Error between the Setpoint and Measured Variable, e(t)=r(t)−y(t).

The control objective is for the controller to produce outputs V₁(t) and V₂(t) to manipulate actuators A; and A₂ so that the measured variable y(t) tracks the given trajectory of its setpoint r(t) under variations of setpoint, disturbance, and process dynamics. In other words, the task of the controller is to minimize the error e(t) in real-time.

Automatic control of the chamber pressure of the EVC apparatus can be a challenge when using a traditional control method. We have to control the chamber pressure based on a varying pressure setpoint trajectory. In addition, the same pressure control system has to deal with varying food types, payload changes, and other uncertainties. Fundamentally, the 1×2 pressure controller has only 1 input, which is the control error e(t) but has to produce 2 control outputs V₁(t) and V₂(t) to manipulate 2 actuators, the vacuum control valve and the inflow air control valve, simultaneously.

In U.S. Pat. No. 7,142,626, Apparatus and Method of Controlling Multi-Input-Single-Output Systems, a 2-Input-1-Output (2×1) Model-Free Adaptive (MFA) control system is described. The Model-Free Adaptive (MFA) control technology as described in U.S. Pat. Nos. 7,142,626, 6,055,524, and 6,556,980 is an artificial intelligence (AI) technology that uses an artificial neural network (ANN) as a key component of the controller. In U.S. patent application No. 17,469,712, adaptive chamber pressure control using Model-Free Adaptive (MFA) control technology has been described.

As shown in FIGS. 5 to 6 of this patent, the chamber pressure of each food chamber is controlled using a 1-Input-2-Output controller, which manipulates a corresponding inflow air control valve and a vacuum control valve, simultaneously. Based on two design embodiments, the vacuum control valve may be installed in the utility module or inside the instrument panel of the food chamber module. The pressure controller of each food chamber module is typically implemented in its corresponding control and monitoring module. This way, each food chamber can work independently regardless of the operating conditions of the other food chambers.

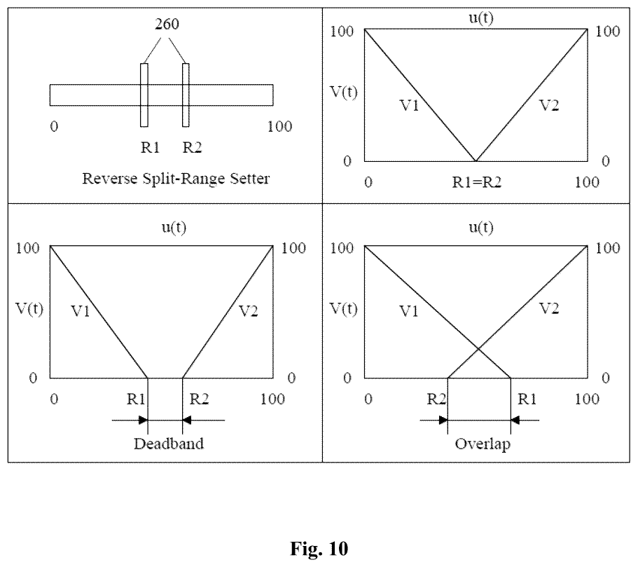

FIG. 10 is a drawing illustrating a mechanism of a reverse split-range setter that can split the controller signal into 2 ranges to manipulate the vacuum control valve and inflow air control valve, according to an embodiment of this invention.

By moving and setting the knobs R₁ and R₂ 260, respectively, the controller outputs V₁(t) and V₂(t) are calculated based on the following formulas as implemented in the split-range setter mechanism 260:

$$\begin{matrix}{V}_{1} ( t ) = - 100 \frac{u ( t )}{{R}_{1}} + 100 , & for all u ( t ) ∈ [ 0 , {R}_{1} ]\end{matrix} \qquad ( 1 a )$$

$$\begin{matrix}{V}_{1} ( t ) = 0 , & for all u ( t ) ∈ [ {R}_{1} , 100 ]\end{matrix} \qquad ( 1 b )$$

where 0<R₁≤100, which defines the split range of u(t) for controller output V₁(t); and

$$\begin{matrix}{V}_{2} ( t ) = - 100 \frac{u ( t ) - 100}{{R}_{2} - 100} + 100 , & for all u ( t ) ∈ [ {R}_{2} , 100 ]\end{matrix} \qquad ( 2 a )$$

$$\begin{matrix}{V}_{2} ( t ) = 0 , & for all u ( t ) ∈ [ 0 , {R}_{2} )\end{matrix} \qquad ( 2 b )$$

where 0≤R₂<100, which defines the split range of u(t) for controller output V₂(t). The signals u(t), V₁(t), and V₂(t) all have a working range of 0% to 100%. In this design, the control valves are shut at 0% during their off position. We can move and set the R₁ and R₂ knobs freely within its (0, 100) range to produce controller outputs V₁(t), and V₂(t), where there may be a deadband, or an overlap, or no gaps in between.

In EVC apparatus chamber pressure control, there are 3 working conditions:
(1) the vacuum control valve is open and inflow air control valve is closed, chamber pressure is decreasing;
(2) both vacuum control valve and inflow air control valve are closed, chamber pressure is holding steady; and
(3) the vacuum control valve is closed and inflow air control valve is open, chamber pressure is increasing.

Then, we can move and set the R₁ and R₂ knobs to have an adequate deadband to support all 3 working conditions. For instance, we can set the R₁=40, and R₂=60. When u(t)<40, the vacuum control valve is open to move air out of the chamber causing the chamber pressure to decrease. Inside the deadband, where 40<u(t)<60, V₁(t)=V₂(t)=0 forcing both control valves to be closed. When u(t)>60, the inflow air control valve is open. Clean air flows into the chamber causing the pressure to increase.

U.S. Pat. No. 7,142,626 also described 2×1 PID (Proportional-Integral-Derivative) control systems which could potentially be useful for chamber pressure control for the EVC apparatus. When the Derivative action is taking out of a PID controller, it becomes a PI controller. When the Integral action is taking out of a PI controller, it becomes a P controller. Both PI and P controllers could potentially be useful for chamber pressure control, although their performance will not be as good as an MFA controller.

### C. Design of Chamber Pressure Setpoint Trajectory for Flavor Infusion

As defined in the opening section of this specification, Extreme Vacuum Cooling (EVC) is vacuum cooling at extremely low pressure conditions with vacuum chamber pressure control and added clean dry air or inert gas. The EVC apparatus disclosed in this patent can marinate or brine meats, vegetables, and fruits.

One major challenge for the EVC apparatus is the potential liquid splash problem for Type B Foods and for food flavor infusion. When the pressure difference between the chamber pressure and vapor pressure of water inside the food is too high, excessive bubbling can occur due to rapid evaporation. For low viscosity foods. such as soups and sauces, and for food flavor infusion with brine and marinade, this liquid splash problem is the main road block for the users. It is important to control the chamber pressure carefully for Type B Foods and for food flavor infusion so that the pressure difference between the chamber pressure and vapor pressure is managed properly and automatically to enable rapid cooling but have no liquid splash events.

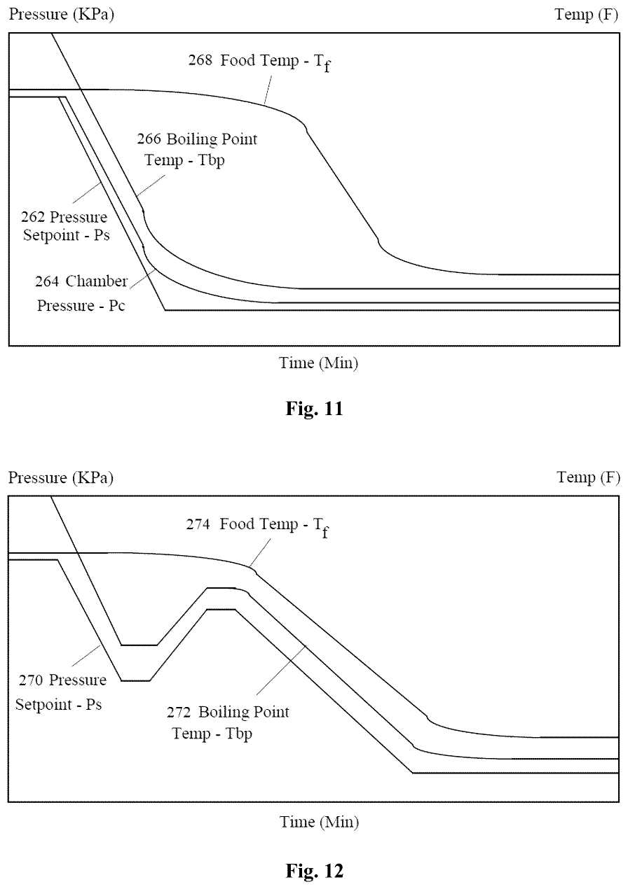

FIG. 11 is a time-amplitude diagram that shows a chamber pressure setpoint trajectory for cooling high viscosity foods, controlled chamber pressure, boiling point temperature, and food temperature, according to an embodiment of this invention. The diagram comprises trends for the pressure setpoint Ps 262, chamber pressure Pc 264, boiling point temperature Tbp 266, and food temperature Tf 268.

Since the liquid splash events do not happen for Type A Foods, we can reduce the vacuum pressure more aggressively based on the capability of the EVC apparatus. For instance, the vacuum pressure setpoint Ps 262 can be designed to change from atmosphere pressure (1.0 ATM or 100 KPa) to extremely low pressure (0.01 ATM or about 1.0 KPa) to achieve rapid vacuum cooling. The chamber pressure Pc 264 can be controlled to track its setpoint Ps. In this case, the 1×2 pressure controller described in Section B will work in its OP range between 0 to 40 to manipulate the vacuum control valve and achieve pressure control, while the inflow air control valve is closed.

The boiling point of a substance is the temperature at which the vapor pressure of a liquid equals the pressure surrounding the liquid when the liquid changes into a vapor. Therefore, in the vacuum chamber, the boiling point temperature of water inside the food is directly related to the chamber pressure. It can be seen that the boiling point temperature Tbp 266 of the water inside the food changes along with the chamber pressure Pc 264. The food inside the chamber cools down gradually and its temperature is measured by the temperature sensors to produce the Food Temp Tf. Please note that there is a time lag between Tbp 266 and Tf 268. For Type A Foods, this temperature difference is not an issue.

For Type A Foods, the chamber pressure setpoint trajectory can be based on the following formula as illustrated in FIG. 11:

Ps(t)=Pi(0)−a*t;During initial ramp down period; (3a)

Ps(t)=C;During the holding and endpoint period. (3b)

In these formulas, Pi(0) is the initial value of the chamber pressure, constant a is the slope of pressure ramp down, and constant C is the pressure setpoint for the EVC apparatus to run at a fixed vacuum pressure. The actual values of the slope and constants are related to the EVC apparatus capability, food viscosity, total weight, and the difference between boiling point temperature and food temperature, etc. They can be derived through experiments and stored in cooling recipes as pre-determined values. Please note, for Type B Foods, if we run the EVC apparatus based on the pressure setpoint trajectory showing in FIG. 11, the big temperature difference of Tbp and Tf can cause liquid splash.

In FIG. 7 of this patent, we described the use of a temperature controller to control the average chamber temperature for all the food chambers in a N×1 EVC apparatus. The pressure and temperature curves of each food chamber could look quite similar to the curves illustrated in FIG. 11.

FIG. 12 is a time-amplitude diagram that shows a chamber pressure setpoint trajectory for cooling low viscosity foods and for food flavor infusion, as well as boiling point temperature and food temperature, according to an embodiment of this invention.

As explained in the opening section of this document, if the pressure difference between the chamber pressure and vapor pressure of water inside the food is too high, excessive bubbling can occur due to rapid evaporation. When the bubbles burst at the food surface, the force of the bubble surface tension can cause the liquid splash inside the chamber for Type B Foods. It is important to control the chamber pressure carefully for Type B Foods and for food flavor infusion so that the pressure difference between the chamber pressure and vapor pressure is managed in such a way that the EVC apparatus can enable rapid cooling or flavor infusion while avoiding liquid splash events.

Since the boiling point temperature has a direct relationship with the chamber pressure, we can also control the chamber pressure with constraints based on the difference between the boiling point temperature and food temperature to avoid liquid splash for Type B Foods. As illustrated in FIG. 12, the chamber pressure setpoint Ps 270 can be reduced at the beginning to give a kick start for vacuum cooling. In this drawing, the measured chamber pressure is not shown but should track the pressure setpoint. In this case, we can assume the chamber pressure is equivalent to the pressure setpoint. The boiling point temperature Tbp 272 comes down as the chamber pressure comes down. After that, we can intentionally hold the pressure for a while and then increase the chamber pressure by closing the vacuum control valve and adding clean dry air into the chamber to reach a pressure level and wait there before the food temperature Tf 274 starts to fall. The goal of adding clean air is to raise the chamber pressure and maintain a temperature difference between Tbp and Tf so that liquid splash will not happen.

As illustrated in FIG. 12, the chamber pressure setpoint trajectory can be calculated based on vapor pressure, boiling point temperature, and viscosity. The formulas to calculate vapor pressure and boiling point temperature relating to viscosity that can be used in this embodiment are any of known techniques described in the book Perry's Chemical Engineers' Handbook, by Don Green and Marylee Z. Southard, published by McGraw-Hill Education, wherein the book and its contents are herein expressly incorporated by reference, in their entirety.

Without losing generality, we can design the chamber pressure setpoint Ps(t) for cooling Type B Foods and for food flavor infusion based on the following formula, which is illustrated in FIG. 12:

Ps(t)=Pi(0)−a*t;During initial ramp down period; (4a)

Ps(t)=C1;During the first holding period; (4b)

Ps(t)=C1+b*t;During the ramp up period; (4c)

Ps(t)=C2;During the second holding period; (4d)

Ps(t)=C2—d*t;During the second ramp down; (4e)

Ps(t)=C3,During the endpoint period. (4f)

In these formulas, Pi(0) is the initial value of the chamber pressure, constants a, b, and d are the slopes of pressure ramp down, ramp up, and final ramp down. Constants C1, C2, and C3 are the pressure setpoints for the EVC apparatus to run at a fixed vacuum pressure. The actual values of the slopes and constants are related to the EVC apparatus capability, food viscosity, total weight, and the difference between boiling point temperature and food temperature, etc. They can be derived through experiments and stored in cooling or flavor infusion recipes as pre-determined values. When doing the experiments, the food or marinade viscosity can be measured using a viscosity analyzer.

For food flavor infusion, salt water is usually used for brining. Marinade can include soy sauce, Teriyaki sauce, buttermilk, yogurt, tomato sauce, wine, liquor, vinegar, papaya juice, orange juice, kiwi juice, pineapple juice, apple juice, olive oil, salt water, or a combination of these ingredients. Viscosity for marinade can be quite different. The chamber pressure setpoint trajectory for marinating can be derived through certain formulas and experiments and saved in a computer database. The user can retrieve the trajectory as part of the brining or marinating recipe when using the EVC cooling and flavor marinating apparatus.

### D. Conclusion

The motivation to develop Extreme Vacuum Cooling (EVC) technology and products fits the mega trend of the food industry transformation. Similar to a semiconductor foundry or fab, a food foundry is a modern commercial kitchen or food processing plant that can produce large amounts of food with special recipes in small packages to serve dedicated or targeted customer groups. In a food fab, the large amount of food needs to be cooked and chilled for future consumption.

In a commercial kitchen, chefs and workers need to prepare large amounts of food with certain time limitations. To make food have better and more unique taste, they often marinate and brine the meats and vegetables before cooking. However, food marinating or brining using conventional methods can take many hours to days, which can become a main bottleneck for the commercial kitchen. Chilling foods rapidly to get cooked foods out of danger zones to meet food safety standards and marinating foods efficiently to save energy and manpower are desirable. However, how to build such an apparatus to achieve these capabilities cost effectively can be a challenge.

In this patent, we introduce a smart and scalable extreme vacuum cooling (EVC) apparatus based on a scalable and modular design so that one or multiple food chamber modules can connect to a utility module so that all food chambers can share the available vacuum cooling capacity dynamically. This unique design is well suited for EVC rapid cooling applications where the vapor load from the food chamber is much smaller than the full capability of the utility module. By sharing the vacuum cooling capacity provided by a utility module, an EVC apparatus with multiple food chambers can save equipment cost, energy consumption and space.

A scalable EVC system can be built, shipped and assembled with as few as one food chamber module and one utility module to a number of food chamber modules and a utility module. The food chambers are designed with different sizes in dimension and power requirements but with the same interface to the utility module. In this way. multiple food chamber modules can operate for food rapid cooling and flavor infusion supported by only one utility module.

In a CEA farm, leafy greens are harvested daily and need to be chilled rapidly to comply with USDA food safety standards. Leafy greens can occupy a lot of space with a small vapor payload in vacuum cooling. The multiple food chamber modules to a single utility module design can save the total system cost, space, and energy.

For food flavor infusion in a commercial kitchen, brining and marinating take time. During the wait time, the food chamber is held at a low pressure condition without the need for pumping air out. During this time, the utility module can serve other food chambers. In this regard, an EVC system with multiple food chamber modules and a single utility module design will work well for food flavor infusion.

The inventors of this patent have many years of experience in technology innovation to serve or even lead the mega trends in the transformation in industrial automation, renewable energy, and semiconductor equipment. It is our goal to contribute to and support the food industry and our society where people are looking for healthier, more flavorful, and affordable foods.

1. An apparatus for cooling, marinating, or brining food capable of operating at extremely low pressure conditions, comprising:
a) one or a plurality of food chamber modules, each comprising:
(i) a food chamber being able to work in extremely low pressure conditions;
(ii) an inflow air control valve arranged to regulate the added clean air flows and serve as a vent valve to allow the food chamber to return to atmosphere pressure; and
(iii) an instrument panel;
b) a utility module being connected to each food chamber, comprising:
(i) a vacuum pump arranged to pump air out of the food chamber to reach extremely low pressure conditions;
(ii) a cold trap arranged to condense water vapor from the food chamber back to liquid form;
(iii) a refrigeration unit being used to cool the cold trap;
(iv) a vacuum control valve arranged to regulate the exhaust air flow;
(v) a vacuum air connection tubing that connects the cold trap to each food chamber and allows air to pass through;
(vi) an electrical panel arranged to receive electric power and supply the power to the apparatus; and
(vii) a conduit that houses the electrical and signal wires in between the food chamber module and utility module;
c) a control and monitoring module for each food chamber, comprising an HMI screen that allows the user to operate the apparatus.

2. The apparatus of claim 1, in which the extremely low pressure conditions have chamber pressure being less than or equal to about 0.1 ATM or 10 kPa.

3. The apparatus of claim 1, in which the control and monitoring module further comprises:
a) a computer and control device that enables chamber pressure control for the apparatus;
b) a system power switch to turn on or off the apparatus; and
c) a plurality of system status lights to indicate the working or abnormal status of the apparatus.

4. The apparatus of claim 1, in which each food chamber module further comprises:
a) an inline air filter to filter the inflow air;
b) a plurality of temperature sensors whose probes can be inserted into food samples to measure food temperatures;
c) a pressure sensor being used to measure the pressure of the food chamber;
d) one or two food chamber doors; and
e) a rolling trolley that can hold multiple food pans, fruit crates, or vegetable cartons.

5. The food chamber module of claim 4, in which the chamber door further comprises:
a) a window to allow the user to view the conditions inside the chamber; and
b) a door handle and swivel to lock the food chamber for safe operations.

6. The apparatus of claim 1, comprising a 2-Input-1-Output (2×1) pressure control system for each of the food chamber module to control the food chamber pressure, further comprising:
a) a 1-input-2-output (1×2) pressure controller;
b) a 2-input-1-output (2×1) pressure system;
c) an actuator 1 being the vacuum control valve;
d) an actuator 2 being the inflow air control valve; and
e) a pressure setpoint trajectory calculation mechanism.

7. The control system of claim 6, wherein the 1-input-2-output (1×2) pressure controller is a Model-Free Adaptive (MFA) controller, a Proportional-Integral-Derivative (PID) controller, a Proportional-Integral (PI) controller, or a Proportional controller (P), comprising a split-range setter to produce control output 1 and 2 to manipulate actuator 1 and 2.

8. The 1×2 pressure controller of claim 7, in which the split-range setter produces controller outputs of the form:
$$\begin{matrix}{V}_{1} ( t ) = - 100 \frac{u ( t )}{{R}_{1}} + 100 , & for all u ( t ) ∈ [ 0 , {R}_{1} ] \\ {V}_{1} ( t ) = 0 , & for all u ( t ) ∈ [ {R}_{1} , 100 ] \\ {V}_{2} ( t ) = - 100 \frac{u ( t ) - 100}{{R}_{2} - 100} + 100 , & for all u ( t ) ∈ [ {R}_{2} , 100 ] \\ {V}_{2} ( t ) = 0 , & for all u ( t ) ∈ [ 0 , {R}_{2} ]\end{matrix}$$
or an equivalent thereof, in which 0<R₁≤100, 0<R₂<100, the signals u(t), V₁(t), and V₂(t) all having a working range of 0 to 100.

9. The 1×2 pressure controller of claim 7, in which the split-range setter is set with the values of R₁ and R₂ to enable three working conditions, in which:
(a) vacuum control valve is open and inflow air flow valve is closed, chamber pressure is decreasing;
(b) both vacuum control valve and inflow air control valve are closed, chamber pressure is holding steady; and
(c) vacuum control valve is closed and inflow air flow valve is open, chamber pressure is increasing.

10. The control system of claim 6, in which the pressure setpoint trajectory calculation mechanism is generated in the following form for cooling Type A Foods:
Ps(t)=Pi(0)−a*t;During initial ramp down period;
Ps(t)=C;During the first holding period;
or an equivalent thereof, in which Pi(0)>0 is the initial chamber pressure, and a>0, C>0 are pre-determined constants being used in cooling recipes.

11. The control system of claim 6, in which the pressure setpoint trajectory calculation mechanism is generated in the following form so the food chamber pressure is controlled to avoid liquid splash events for food flavor infusion and for cooling Type B Foods:
Ps(t)=Pi(0)−a*t;During initial ramp down period;
Ps(t)=C1;During the first holding period;
Ps(t)=C1+b*t;During the ramp up period;
Ps(t)=C2;During the second holding period;
Ps(t)=C2−d*t;During the second ramp down period;
Ps(t)=C3,During the endpoint period;
or an equivalent thereof, in which Pi(0)>0 is the initial chamber pressure, and a>0, b>0, d>0, C1>0, C2>0, C3>0 are pre-determined constants being used in cooling recipes.

12. The computer and control device of claim 3 being implemented with an industrial personal computer (IPC), or a programmable logic controller (PLC), or a programmable automation controller (PAC), or a specially designed control device, or a combination thereof.

13. An apparatus for cooling, marinating, or brining food capable of operating at extremely low pressure conditions, comprising:
a) one or a plurality of food chamber modules, each comprising:
(i) a food chamber being able to work in extremely low pressure conditions;
(ii) a vacuum control valve arranged to regulate the exhaust air flow;
(iii) an inflow air control valve arranged to regulate the added clean air flows and serve as a vent valve to allow the food chamber to return to atmosphere pressure; and
(iv) an instrument panel;
b) a utility module being connected to each of the food chamber, comprising:
(i) a vacuum pump arranged to pump air out of the food chamber to reach extremely low pressure conditions;
(ii) a cold trap arranged to condense water vapor from the food chamber back to liquid form;
(iii) a refrigeration unit being used to cool the cold trap;
(iv) a vacuum air connection tubing that connects the cold trap to each food chamber and allows air to pass through;
(v) an electrical panel arranged to receive electric power and supply the power to the apparatus; and
(vi) a conduit that houses the electrical and signal wires in between the food chamber module and utility module;
c) a control and monitoring module for each food chamber, comprising an HMI screen that allows the user to operate the apparatus.

14. The apparatus of claim 13, in which the extremely low pressure conditions have chamber pressure being less than or equal to about 0.1 ATM or 10 kPa.

15. The apparatus of claim 13, in which the control and monitoring module further comprises:
a) a computer and control device that enables chamber pressure control for the apparatus;
b) a system power switch to turn on or off the apparatus; and
c) a plurality of system status lights to indicate the working or abnormal status of the apparatus.

16. The apparatus of claim 13, in which each food chamber module further comprises:
a) an inline air filter to filter the inflow air;
b) a plurality of temperature sensors whose probes can be inserted into food samples to measure food temperatures;
c) a pressure sensor being used to measure the pressure of the food chamber;
d) one or two food chamber doors; and
e) a rolling trolley that can hold multiple food pans, fruit crates, or vegetable cartons.

17. The apparatus of claim 13, comprising a 2-Input-1-Output (2×1) pressure control system for each of the food chamber module to control the food chamber pressure, further comprising:
a) a 1-input-2-output (1×2) pressure controller;
b) a 2-input-1-output (2×1) pressure system;
c) an actuator 1 being the vacuum control valve;
d) an actuator 2 being the inflow air control valve; and
e) a pressure setpoint trajectory calculation mechanism.

18. An apparatus for cooling fresh produce and marinating or brining foods, comprising:
a) one or a plurality of food chamber modules, each comprising:
(i) a food chamber;
(ii) an inflow air control valve arranged to work as a vent valve to allow the food chamber to return to atmosphere pressure; and
(iii) an instrument panel;
b) a utility module being connected to all food chamber modules, comprising:
(i) a vacuum pump arranged to pump air out of the food chamber;
(ii) a cold trap arranged to condense water vapor from the food chamber back to liquid form;
(iii) a refrigeration unit being used to cool the cold trap;
(iv) a vacuum control valve arranged to regulate the exhaust air flow;
(v) a vacuum air connection tubing that connects the cold trap to each food chamber and allows air to pass through;
(vi) an electrical panel arranged to receive electric power and supply the power to the apparatus; and
(vii) a conduit that houses the electrical and signal wires in between the food chamber module and utility module;
c) a control and monitoring module for each food chamber, comprising an HMI screen that allows the user to operate the apparatus.

19. The apparatus of claim 18, in which the control and monitoring module further comprises:
a) a computer and control device that enables food temperature control or chamber pressure control for the apparatus;
b) a system power switch to turn on or off the apparatus; and
c) a plurality of system status lights to indicate the working or abnormal status of the apparatus.

20. The apparatus of claim 18, in which each food chamber module further comprises:
a) a plurality of temperature sensors whose probes can be inserted into food samples to measure food temperatures;
b) a pressure sensor being used to measure the pressure of the food chamber;
c) one or two food chamber doors; and
d) a rolling trolley that can hold multiple food pans, fruit crates, or vegetable cartons.

21. The apparatus of claim 18, comprising a temperature control system to control the food chamber temperature, further comprising:
a) a single-input-single-output (SISO) controller;
b) food chamber temperature to be controlled; and
c) an actuator being the vacuum control valve.

22. The temperature control system of claim 21, further comprising a calculation mechanism to calculate the average value of the food temperature of all food chambers, in which the average food temperature is used as the measured process variable for the single-input-single-output (SISO) controller.

23. The apparatus of claim 18, comprising a pressure control system to control the food. chamber pressure, further comprising:
a) a single-input-single-output (SISO) controller;
b) food chamber pressure to be controlled; and
c) an actuator being the vacuum control valve.

24. The pressure control system of claim 23, further comprising a calculation mechanism to calculate the average value of the pressure of all food chambers, in which the average pressure is used as the measured process variable for the single-input-single-output (SISO) controller.
